(19) United States
(12) Patent Application Publication
(10) Pub. No.: US 2008/0109764 A1
(43) Pub. Date: May 8, 2008

(54) Interface for selecting audio-video sources in a limited display environment

(76) Inventor: Mikko Linnamaki, Stuttgart (DE)

Correspondence Address: CARR & FERRELL LLP, 2200 GENG ROAD, PALO ALTO, CA, 94303, US

(21) Appl. No.: 11/594,468

(22) Filed: Nov. 7, 2006

(51) Int. Cl. G06F 17/00

(52) U.S. Cl. 715/864

(57) ABSTRACT

Methods for the rendering of information regarding available audio and video sources in a limited display environment are provided. Display environments, especially in mobile devices, are limited with regard to physical space and technical capability. The present invention provides for the display and selection of available audio and video sources in light of those limitations.

### CROSS-REFERENCE TO RELATED APPLICATIONS

This application is related to U.S. patent application Ser. No. 11/______ filed Nov. 7, 2006 (Express Mail Label EV 826 333 254 US) and entitled “Multi-Radio Mobile Application,” the disclosure of which is incorporated herein by reference. The aforementioned application is commonly owned and assigned.

### BACKGROUND OF THE INVENTION

1. Field of the Invention

The present invention relates generally to the field of user interfaces. More specifically, the present invention relates to the rendering of information regarding available audio sources in a limited display environment by user interfaces, those interfaces operating across various platforms in various mobile devices.

2. Description of the Related Art

Mobile data access devices make it simple and affordable to access the internet anywhere there is wireless access. Software allowing for such access is becoming a standard feature on a variety of mobile devices, such as Pocket PCs, cellphones, PDAs, various hand-held game machines, and other similar devices. Such access may be through the cellular network, a WiFi connection, a WiMax connection, 3G, GPRS or some other wireless connection.

Such devices also commonly include the ability to store and play audio files, such as MP3 files, WAV files, AAC files and other formats. The wide success of electronic music players shows the interest of consumers in having access to music anywhere. In addition, an entire class of audio has come to be known as “podcasts”; podcasts are typically audio recordings of some spoken event, such as a speech, class, radio or television show, etc., but may encompass other types of recordings as well.

However, typically such audio players contain audio files that have been previously downloaded from a computer, either having been created locally on the computer, or having been downloaded to or through the computer from a source on the internet, either as a free download or purchased commercially through an online music store. Despite mobile devices becoming a staple in personal and commercial enterprise, it is difficult for users to obtain music or other audio files not previously stored on a device to be played or downloaded using only wireless access. Some providers of wireless phone service provide for the sale of songs, in a fashion similar to what an online music store provides, but each song must be purchased and downloaded separately, a tedious process.

One of the problems in enabling the ability of mobile devices to find available music to download without access to a computer is that the screen size of most mobile devices is significantly smaller than the typical screen size of a laptop or desktop computer. In addition, most music players use text based navigation systems, and in many instances the quantity of text is large enough to exceed the limits of small displays. Thus, it is often difficult to present sufficient information in the limited user interface display environment of most mobile devices for the user to interact with the internet with regard to locating music sources in a meaningful way.

There are tens of millions of people who make up the ‘mobile population,’ that is, individuals who carry mobile devices away from a physical internet connection or other access to music not already stored on their mobile device. With the increasing number of on-the-go people, electronic music continues to be a very desirable application. As a result, this population has an inherent need for mobile access to additional music that is not already present on their mobile devices.

There is, therefore, a need in the art for a user interface for selecting music sources that will work on multiple platforms and devices having limited user interface display environments and will allow the user to easily select from a wide variety of audio sources.

It should be noted, in the course of this disclosure, that while a device (e.g., hardware) and platform (e.g., software) are recognized as distinct-albeit related-entities, any reference to a device or a platform should be considered inclusive of both. Similarly, any reference to audio should be considered inclusive of video as well.

### SUMMARY OF THE INVENTION

The present invention provides methods for the rendering of information regarding available audio and video sources in a limited display environment. The present invention provides for the display and selection of Identification and selection of available audio and video sources may be easily accomplished notwithstanding the physical space limitations of such environments.

In one embodiment, a method for selecting audio and/or video sources in a limited user interface display environment comprises: selecting a plurality of items for presentation in the limited user interface display environment, the plurality of items selected from a set of information; rendering the information such that the selected plurality of items sequentially scroll across the limited user interface display environment; activating a user interface module, the user interface module configured to select a desired item from the set of information for rendering in the limited user interface display environment; and rendering the desired item of information in the limited user interface display environment.

The above-described embodiments are exemplary. One skilled in the art will recognize and appreciate various applications of the disclosed invention beyond those presently described here. This disclosure is not meant to be limiting beyond those limitations as expressly provided in the claims.

### BRIEF DESCRIPTION OF THE DRAWINGS

FIG. 1A illustrates an exemplary embodiment of a network in which methods for selecting audio or video sources in a limited user interface display environment may be used as described in the present invention.

FIG. 2 is a block diagram showing the principal components of a mobile device having a limited user interface display environment on which methods for selecting audio or video sources might be used as described in various embodiments of the present invention.

FIG. 3 illustrates an exemplary embodiment of a startup display as may be used in the present invention.

FIGS. 4a-9d illustrate exemplary embodiments of various displays as may be used in the present invention.

### DETAILED DESCRIPTION OF AN EXEMPLARY EMBODIMENT

While the exemplary embodiment contained herein is presented with respect to displaying information about and selecting available audio sources in a limited user interface display environment, it will be apparent that the same methods may be employed in dealing with video sources as well. No limitation of the invention is implied other than as expressly stated by the claims.

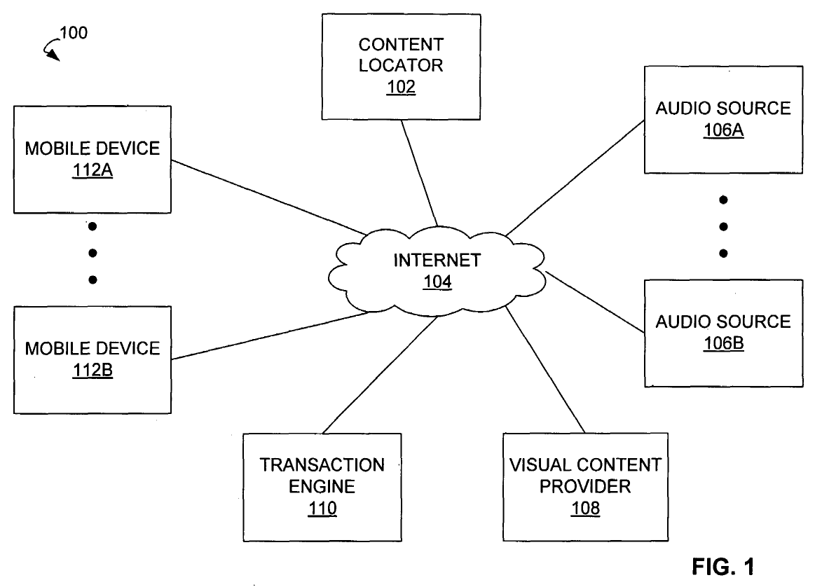

FIG. 1 illustrates an exemplary embodiment of a network environment 100 in which the present invention may be utilized. A plurality of mobile wireless devices 112A and 112B are connected to a plurality of audio sources 106A and 106B through the internet 104. A content locator 102 is configured to locate the audio sources 106A and 106B on the Internet 104 and to provide information to mobile devices 112A and 112B.

According to some embodiments, the content locator 102 may be provided by a service to which a user of a mobile device 112A or 112B subscribes. Such a service may be provided by a wireless service provider, a cellular service provider, an internet access provider, or some other vendor. In some embodiments, content locator 102 includes a web crawler engine that browses and indexes audio sources on the World Wide Web (WWW). Content locator 102 may index audio sources according to type, genre, geographic location, language, and the like. Content locator 102 further stores a network address, such as a uniform resource locator (URL), associated with each audio source 106A and 106B. Content locator 102 may also store audio content retrieved from audio sources 106A and 106B that can be downloaded by mobile devices 112A and 112B.

Any given audio source 106A and 106B may provide live radio broadcast streams, personalized radio services, music on-demand providers, and/or podcasts. Each audio source 106A and 106B is associated with a network address accessible via the Internet 104. Alternatively, the audio sources 106A and 106B may also provide downloadable media that can be downloaded to the content locator 102 or directly to the mobile devices 112A and 112B. In other embodiments, the audio sources 106A and 106B may transmit streaming radio broadcasts or personalized radio broadcasts as streaming. audio accompanied by sync data. The sync data may contain metadata associated with the streaming audio data such as a song title, artist, studio, release date, or the like. Metadata may also be included in or with podcast files.

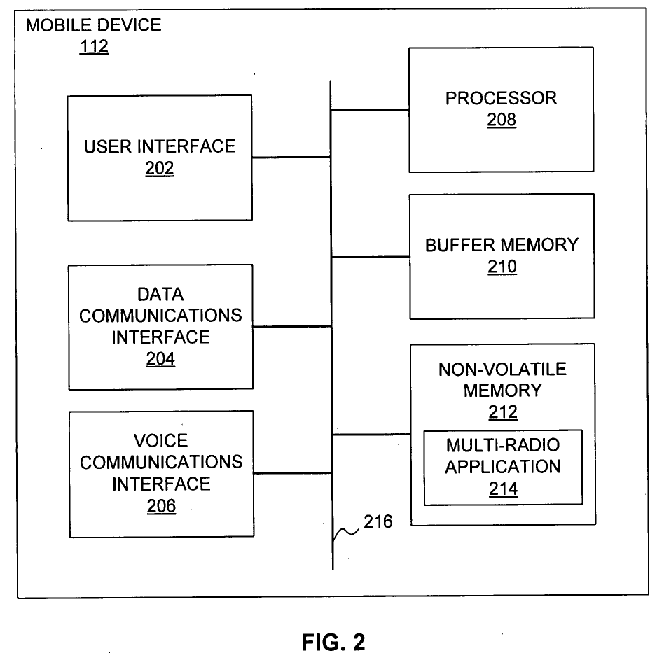

FIG. 2 is a block diagram showing the principal components of a mobile wireless device 112 such as may be used with various embodiments of the present invention. The mobile device 112 comprises a user interface 202, a data communications interface 204, a voice communications interface 206, a processor 208, a buffer memory 210, and a non-volatile memory 212 connected by a bus 216.

The user interface 202 enables the user to interact with the mobile device 112 and may comprise a display, a speaker, a keypad, and/or a microphone. The data communications interface 204 is configured to transmit and receive data using a wireless data communications network, such as a cellular network, WiFi network, WiMax network, #G, GPRS, etc. The voice communications interface 206 is configured to communicate over a cellular communications network for voice calling. The processor 208 is configured to execute instructions stored in the buffer memory 210 and the non-volatile memory 212. The buffer memory 210 comprises a re-writeable memory such as random access memory (RAM) or Flash memory. The non-volatile memory 212 may comprise read-only memory (ROM) and/or Flash memory and may be used to store audio and video files and applications that can be executed by the processor 208 to perform functions on wireless mobile device 112.

A multi-radio application 214 is stored in the non-volatile memory 214. The multi-radio application 214 is a program executable by the processor 208 to receive radio content on the mobile device 112 from audio sources such as audio sources 106A and 106B. In some embodiments, the multi-radio application 214 is updatable by the content locator 102. The multi-radio application 214 may direct the processor 208 to play streaming audio, or to store streaming audio and/or visual data in the buffer memory 210. Audio downloads, such as podcasts and/or music on-demand may be stored in the non-volatile memory 212.

Various embodiments of the present invention are illustrated below with respect to a cellphone, specifically the Nokia N70; however, it will be recognized those familiar with wireless devices that the same methods may be used with any cellphone or any other mobile device having a limited user interface display environment and wireless access.

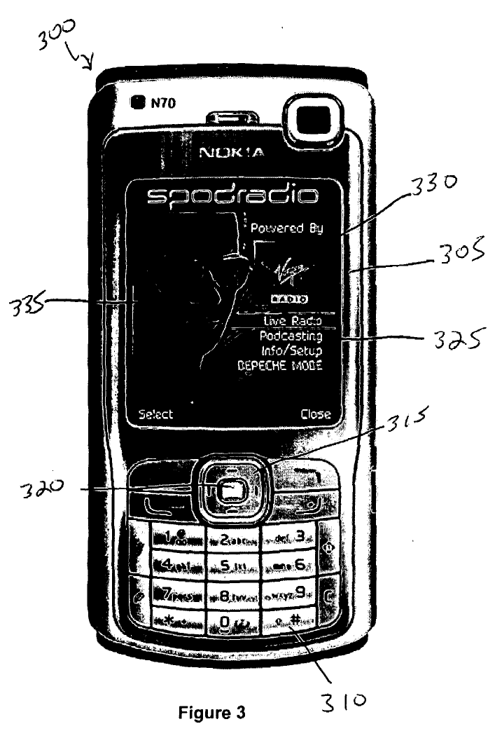

FIG. 3 illustrates an exemplary cellphone 300 and an exemplary embodiment of a startup display such as may be used in the present invention. Cellphone 300 has a display 305 and a keypad 310. A directional pad 315 is provided, along with a select button 320. Select button 320 is sometimes labeled “enter” or “OK.” In many or most cellphones and some other wireless mobile devices, directional pad 305 allows the user to move a cursor or highlighted area up, down, left or right, and select button 320 allows the user to select the highlighted area, option or command. Directional pad 315 may be used to move the highlighted area up or down so that the next option up or down respectively is highlighted. Pushing select button 320 causes the application to select the highlighted option.

Other methods of selection may be used. Many PDAs use a stylus, for example, which may be touched to the screen where a particular word, phrase or selection box or button appears to select that option. Other devices may use different means of selecting one of the displayed options. All of these are within the scope of the present invention.

In one embodiment of the present invention, display 305 presents a startup screen containing a menu 325 which provides the user with various options; as illustrated here, those options are “Live Radio” (listen to a radio channel), “Podcasting”. (locate and listen to a podcast), “Info/Setup” (providing information about the audio application described herein and allowing the user to change settings or preferences), and an advertising link entitled “DEPECHE MODE” (allowing access to information about the musical group of that name). In the display shown in FIG. 3, a “Powered By” section contains an icon 330 representing a featured radio channel or podcast, in this case Virgin Radio. There is also a large space 335 in display 305; as illustrated, it contains a picture related to the advertising link for Depeche Mode, but may be used for any other content that is desired. The default contents, layout, colors, and other components of display 305 are typically provided, updated and controlled by the provider of the audio or video service, and may be predetermined or dynamically changed as desired.

The various portions of display 305 allow for access to functions of the audio or video application. For example, menu items may be selected. As illustrated in FIG. 3, “Live Radio” is highlighted. Directional pad 315 may be used to select a different one of the options presented, or select button 320 may be pushed to select, in this instance, the Live Radio portion of the application.

Alternatively, non-menu portions of display 305, when selected, may also lead to functions of the application. In the illustrated display, selecting the “Powered By” icon leads to a direct connection to the featured audio channel or podcast.

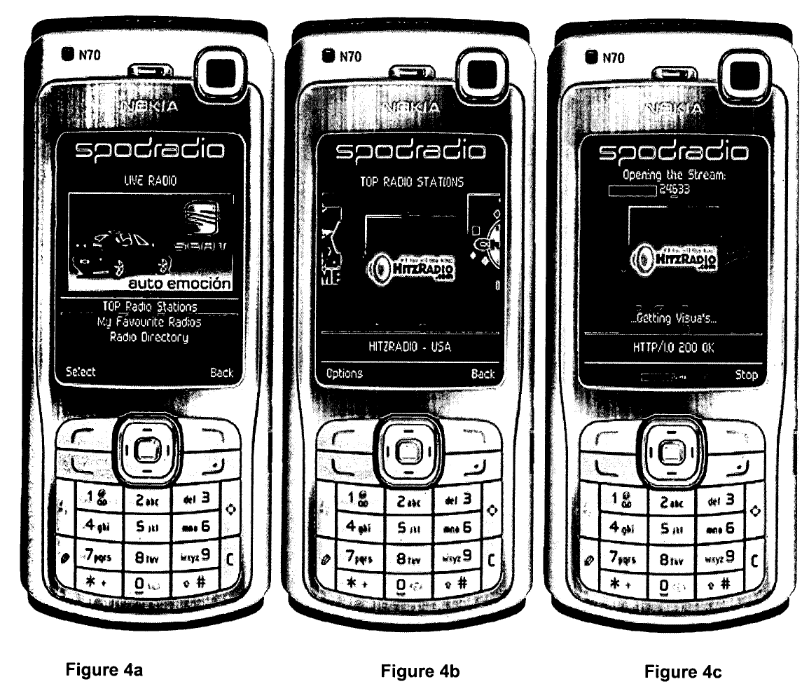

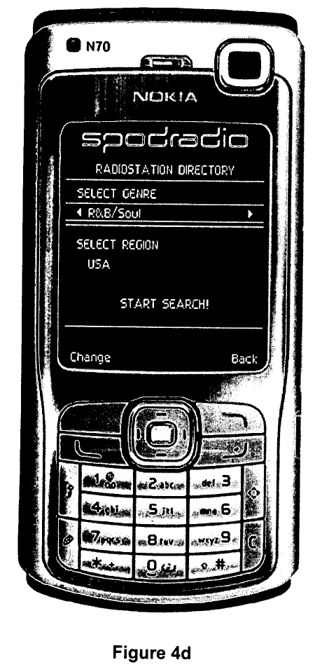

FIG. 4a illustrates an exemplary embodiment of a display such as may be provided when the user selects “Live Radio” on the display of FIG. 3. The user is presented with a second level of options from which to choose; as illustrated. Each of these functions will be discussed in turn. In addition, another advertisement space is available, here showing an advertisement for SEAT; again, this may be dynamically updated by the service provider.

If, for example, the user selects “Top Radio Stations” from the list in FIG. 4a, he might be presented with a display such as that shown in FIG. 4b. In FIG. 4b, it can be seen that three icons 420, 425 and 430 are shown, icon 420 in full and labeled “HitzRadio,” and icons 425 and 430 in part, one to the left of icon 420 and one to the right of icon 420.

In one embodiment as shown here, these icons represent various available radio stations which, in addition to broadcasting over the airwaves, allow their signals to be “broadcast” as streaming audio over the internet. As shown here, the icons scroll sequentially from left to right (or right to left) so that each icon in turn is displayed in full, with a “gravity effect” that draws the fully displayed icon down toward the bottom of the screen for emphasis. Alternatively, the display may be arranged such that the icons scroll from top to bottom or bottom to top. The user may select one of the icons by using the select button 320, or other appropriate means for the device being used.

The stations displayed are the “top” stations according to some criteria; for example, they may be the stations most recently requested by the user, those most requested by other users of mobile devices, the available stations having the most listeners, or meeting some other predetermined criteria. The selection of top stations may be dynamically changed, i.e., the top stations may change at any time if, for example, a different station becomes the most popular. The selection of top stations may also be context sensitive, i.e., a user in England might see a different selection of top stations than a user in Germany or a user in the United States. Similarly, if the interface has for example been tailored to the provider of wireless service for the specific mobile device, or to a particular web portal, the list of top stations may be different than the list for a user with a different wireless service provider, or using a different web portal.

FIG. 4c illustrates an exemplary embodiment of a display such as may be provided when the user selects one of the available stations by selecting one of the icons in FIG. 4b. As illustrated here, the user has selected the station “HitzRadio” and the display indicates that the audio stream is being opened using an appropriate wireless access point and will begin to play through cellphone 300 shortly. In some embodiments, the icon displayed may change to represent the specific song being played or the artist; for example, the icon might (but need not) be the album cover for the album from which the song comes.

FIG. 4d illustrates an exemplary embodiment of a display such as may be provided when the user selects a different option from the display shown in FIG. 4a, specifically the option “Radio Directory.” As illustrated, the user may use a display interface to search a directory for radio stations meeting some user criteria, for example, the shown criteria of musical genre and region. In this illustration, the requested genre may be changed from “R&B/Soul” by using directional pad 315 to point left or right to the next genre on a list, as illustrated by the arrows on either side of “R&B/Soul,” until the desired genre is displayed. The user may select the region by the same method or another method. The user may then use directional pad 315 to move the highlighted region down to the command “start search” and then select that command with the select button 320. The radio stations meeting those criteria may then be displayed in the same manner shown in FIG. 4b, for example.

If desired, a particular station located by such a search, such as HitzRadio, may be added to a list of favorite stations so that selecting “My Favorite Radios” in FIG. 4a results in a scrolling display of all stations designated by the user as favorite stations.

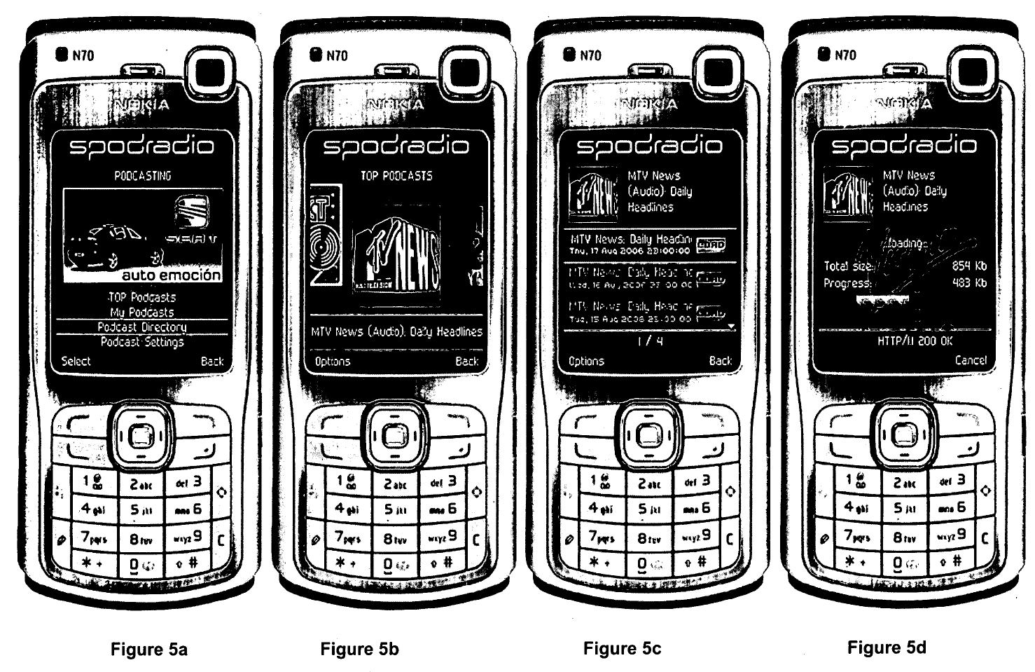

The same interface may be used for other types of audio. FIG. 5a illustrtes an exemplary embodiment of a display such as may be provided when the user selects the option “Podcasting” in FIG. 3. As with the Live Radio displays of FIGS. 4a-4d, various displays relating to available podcasts may be displayed. FIG. 5a allows the user to make various choices about how he wishes to locate available podcasts, similarly to the way in which the display of FIG. 4a allows the user to make choices about available radio stations.

For example, FIG. 5b illustrates an exemplary embodiment of a display such as may be provided when the user selects “Top Podcasts” in FIG. 5a. Similarly to the display of top radio stations in FIG. 4b, the display illustrated in FIG. 5b shows a list of top podcasts, according to some predetermined criteria, as a scrolling display of icons, each of which represents a podcast source. The user may select a podcast source by selecting the corresponding icon by using the select button 320 (or other means appropriate for the specific device).

Also as with the top radio stations, the selection of top podcasts may be dynamic and may change at any time as different podcasts meet or fail to meet the chosen criteria for “top” podcasts. Similarly, the selection of top podcasts may also be context sensitive, for example, listing only podcasts in an appropriate language for the assumed home country of the user (i.e., where the user subscribes to wireless service), or tailored to the particular provider of wireless service for the specific mobile device or to a particular web portal.

FIG. 5c illustrates an exemplary embodiment of a display such as may be provided when the user selects a particular podcast source, here shown as MTV News. A list of available episodes from an RSS feed from MTV News is shown, and one may again be selected by use of the select button 320 or other selection means, for example, the MTV News podcast for Aug. 17, 2006, shown highlighted here. Alternatively, a list of non-episodic podcasts available from a particular source may be presented where desired. If the name of the episode or podcast is too long to fit into the display, it may be scrolled across the screen

FIG. 5d illustrates an exemplary embodiment of a display such as may be provided when the user selects a specific podcast from a list, such as the list shown in FIG. 5c. The display illustrated in FIG. 5d shows the requested podcast being downloaded and statistics about the download of the audio file containing the podcast, such as the total size of the file, and the progress of downloading both as the amount of the file downloaded and as a progress bar. If the download has not yet begun, the display may typically contain a button “Download” button or command which must be selected before the download begins; alternatively, selecting the podcast in FIG. 5c may automatically cause the download to begin. The display may contain such other information, or be in such other form, as is desired.

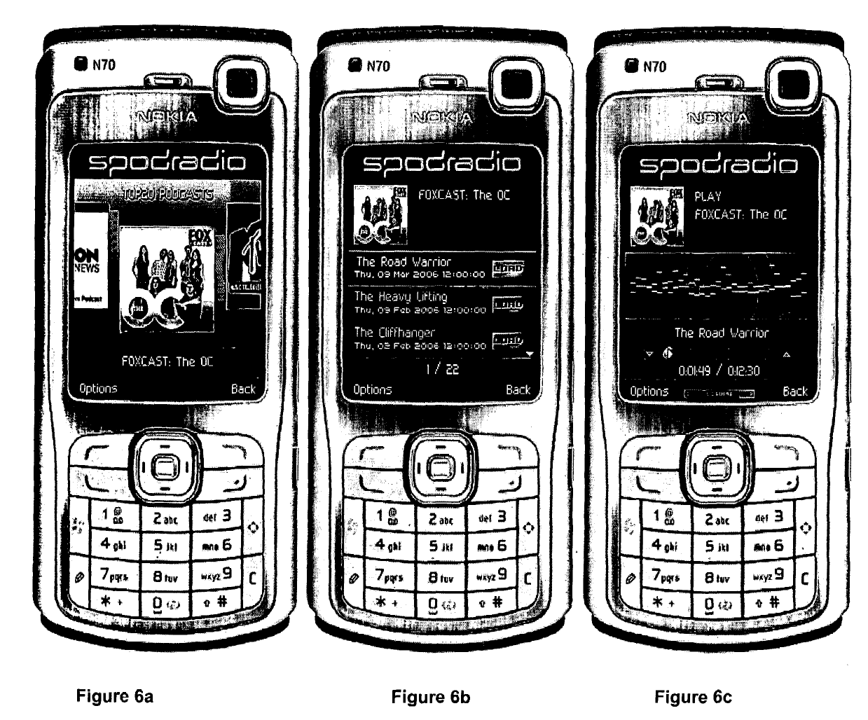

FIG. 6a illustrates another exemplary embodiment of a display such as may be provided when the user selects “Top Podcasts” in FIG. 5a, here labeled “Top20 Podcasts.” FIG. 6b illustrates another exemplary embodiment of a display such as may be provided when the user selects a podcast source, similarly to FIG. 5b, but here showing a different list of sources, including audio files of the television show “The OC.” FIG. 6c illustrates an exemplary embodiment of a display such as may be provided when the user selects a specific podcast from the list of FIG. 6b, here a podcast titled “The Road Warrior” from March 9, which has been downloaded previously, or after the downloading process shown in FIG. 5d is complete. As opposed to the display shown in FIG. 5d, which shows the progress in downloading the audio file, the display of FIG. 6c shows the progress of playing the file, including the total time of the file, the time elapsed in the playback, and/or any other desired information. The display may contain a “Play” button or command which must be selected to begin play, or selection from the menu of FIG. 6b may automatically begin play if the podcast has been previously downloaded.

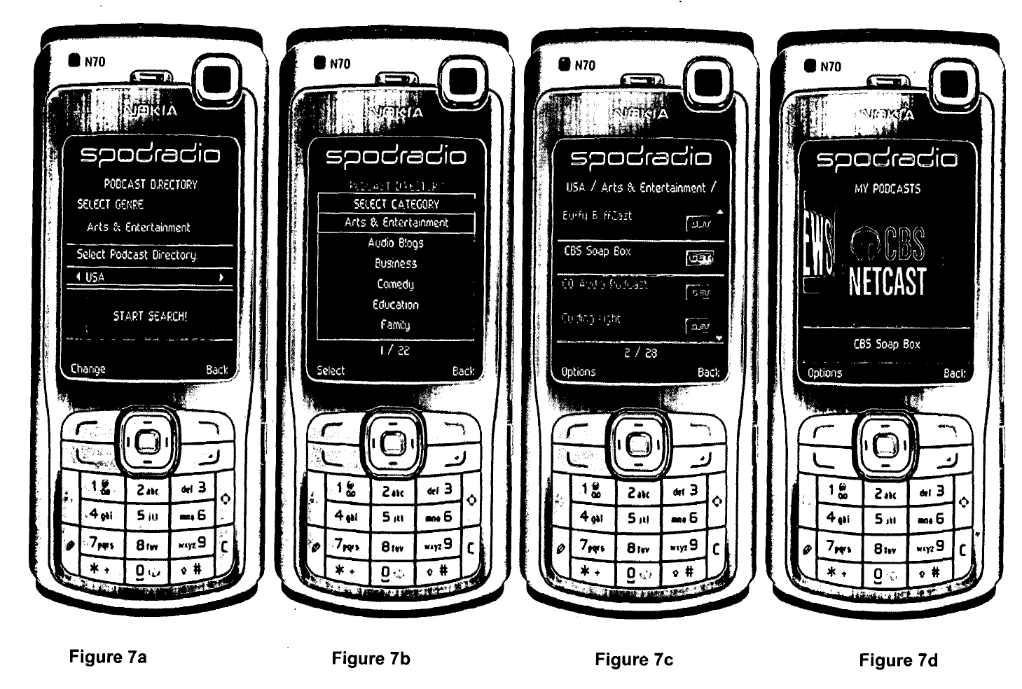

FIG. 7a illustrates an exemplary embodiment of a display such as may be provided when the user selects a different option from the display shown in FIG. 5a, specifically the option “Podcast Directory.” As illustrated, the user may use a display interface to search a directory for podcasts meeting some user criteria, for example, the shown criteria of genre and location. As shown, the genre Arts & Entertainment is selected, with a location of the United States. In this illustration, the requested region may be changed from “USA” by using directional pad 315 to point left or right to the next location on a list, as illustrated by the arrows on either side of “USA,” until the desired location is displayed. The user may select the genre by the same method or another method. The user may then use directional pad 315 to move the highlighted region down to the command “start search” and then select that command with the select button 320.

FIG. 7b illustrates an exemplary embodiment of an alternative display such as may be provided to the user to allow the selection of a podcast genre. As illustrated, rather than the left and right arrows shown in FIG. 7a, the user is presented with a menu of genres from which to choose; here, the genre of Arts & Entertainment is shown highlighted.

FIG. 7c illustrates an exemplary embodiment of a display such as may be provided when the user selects a genre from the display of either FIG. 7a or FIG. 7b. As illustrated, a number of podcasts within the genre Arts & Entertainment from the designated region are listed. Selecting a podcast from the display of FIG. 7c may result, for example, in the exemplary display shown in FIG. 7d of the podcast highlighted and selected in FIG. 7c. Alternatively, the list of podcasts of FIG. 7c may be represented as a set of scrolling icons as above.

Any particular podcast may be designated as a favorite by a user, such that selecting “My Podcasts” in FIG. 5a results in a display of the podcasts so designated.

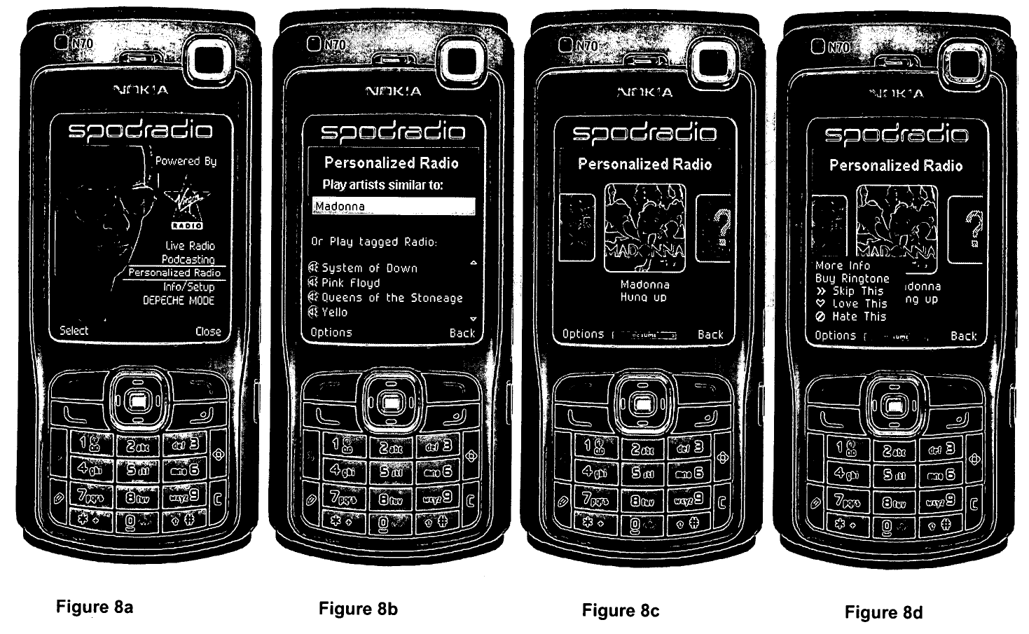

The interface of the present invention also allows for personalization by the user. As one example, FIG. 8a illustrates an exemplary embodiment of an alternative startup display. As compared with the display shown in FIG. 3, the display of FIG. 8a adds the option “Personalized Radio.” This option may, for example, be used to take a user to an interface that is personalized for the user.

In some embodiments, the user will be presented with a screen that requires him to sign in with a user ID and/or password for security purposes. Such a screen is not illustrated herein.

FIG. 8b illustrates an exemplary embodiment of a display for “Personalized Radio” such as might be displayed when the user selects “Personalized Radio” in FIG. 8a. In this example, the user is presented with a search bar, and with a list of “Tagged Radio.” The search bar may be used to enter text to search for a particular artist, album or song. The “Tagged Radio” list contains identifiers for users of a social network and represents links to music profiles created by the listed members of the social network, here shown as Down, Pink Floyd, Queens of the Stoneage, and Yello. Once the user selects a search term or “tag,” a request is sent to create a personalized radio channel for the user based upon the stated criteria. In the illustrated example, the user has indicated a preference for music by, or similar to that of, Madonna.

FIG. 8c illustrates an exemplary embodiment of a display such as might be displayed when the user selects one of the options presented in FIG. 8b. As illustrated here, the user has selected Madonna as the current preference. In response, the system is playing a Madonna album named Hung Up and displays an appropriate icon (here the album cover) and the name of the album to the user. In alternative embodiments, the display might indicate the name of a particular song from that album. As above, the system might select a different album or song “similar to” Madonna and in that case would display a different icon. In some embodiments, using a modified interface not shown here, the user may choose to limit the search to Madonna and exclude similar artists.

As illustrated in FIG. 8c, the icon partially shown to the left of the fully rendered Madonna icon represents the previous song played. In this embodiment, the icon to the right of Madonna is empty, indicating a future song not yet selected. The user may navigate back to songs previously played using the directional pad 315. If the user scrolls to the left to the previous song, the current Madonna icon will move into the position on the right, indicating that this song is a later selection to the one in the center position of the display.

In alternative embodiments, the icons partially shown to the left and right of the Madonna icon in FIG. 8c may be used in other ways. For example, in one embodiment, the other icons might be album covers for other Madonna albums, and selecting one of them could result in obtaining the music from that album. In another embodiment, the other icons might represent artists similar to Madonna, and selecting one of them could result in switching to an audio source containing material from that artist. In still another embodiment, the icons could represent other personalized channels of the user.

FIG. 8d illustrates an exemplary embodiment of a display such as might be displayed when the user selects the item “Options” in FIG. 8c. As illustrated here, the user is given the option to get more information about the album or song playing and/or the artist, to buy a ringtone based on the song or other songs, to skip the song and go to the next song, or to indicate that he “loves” or “hates” the song, which will indicate to the audio source that the user either wants more music from the artist or similar songs, of that the user wishes to ban the song or artist from future play (assuming that the audio source is configured to take such “loves” and “hates” opinions into account in determining what music to present).

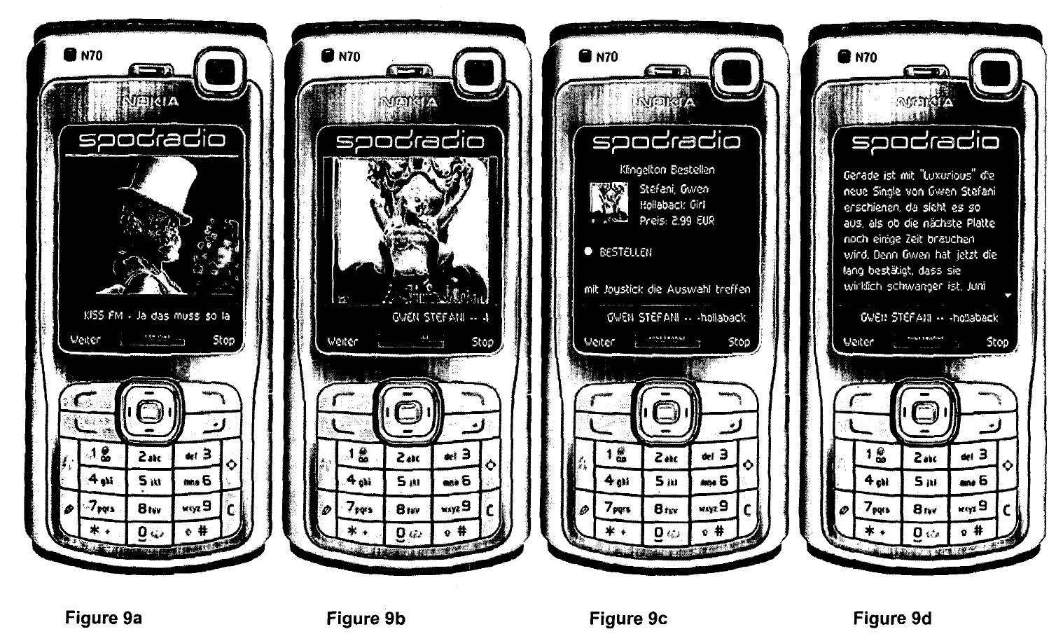

FIG. 9a illustrates an exemplary embodiment of a display such as might be displayed when the streaming audio is a song. The audio source may, as above, send metadata with the audio stream, the metadata containing the image or video to be displayed while the song is playing. In the illustrated example, the artist, Gwen Stefani, is pictured while her song plays. FIG. 9b illustrates an exemplary embodiment of another display such as might be displayed when the song is playing, if, for example, the metadata indicates that images should be shown in some timed sequence or loop like a slide show.

FIG. 9c illustrates an exemplary embodiment of a display such as might be displayed when the user indicates a desire to purchase a ringtone of the song, here shown as containing the price, cover image of the album containing the song, and the song title. From this screen the user can choose to purchase the song.

FIG. 9d illustrates an exemplary embodiment of a display such as might be displayed when the user requests additional information about an artist or song. Such data may be obtained automatically from a networked source, such as a news site, recording company site, Wikipedia, social network, or other source, or provided directly from the audio source.

The above-described embodiments are exemplary. One skilled in the art will recognize and appreciate various applications of the disclosed invention beyond those presently described here. The use of different mobile wireless devices, different display layouts, backgrounds and/or colors, different methods of navigating the display, such as directional keys rather than a directional pad, different methods of entering text or selecting a highlighted item, and/or different names for options or functions are all contemplated. Accordingly, this disclosure is not meant to be limiting beyond those limitations as expressly provided in the claims.

What is claimed is:

1. A method for presenting information in a limited user interface display environment, comprising:
selecting a plurality of items for presentation in the limited user interface display environment, the plurality of items selected from a set of information;
rendering the information such that the selected plurality of items sequentially scroll across the limited user interface display environment;
activating a user interface module, the user interface module configured to select a desired item from the set of information for rendering in the limited user interface display environment; and
rendering the desired item of information in the limited user interface display environment.

2. The method of claim 1, wherein the plurality of items comprise icons.

3. The method of claim 1, wherein the plurality of items comprise short cut keys.

4. The method of claim 1, wherein the plurality of items comprise identification of available sources of streaming audio.

5. The method of claim 4, wherein selecting a desired item from the set of information comprises selecting a streaming audio signal from an audio source.

6. The method of claim 1, wherein the plurality of items comprise identification of available audio files.

7. The method of claim 6, wherein selecting a desired item from the set of information comprises selecting an audio source for download of an audio file.

8. The method of claim 1, wherein the plurality of items comprise identification of available sources of streaming video.

9. The method of claim 8, wherein selecting a desired item from the set of information comprises selecting a streaming video signal from a video source.

10. The method of claim 1, wherein the plurality of items comprise identification of available video files.

11. A method for presenting menu information in a limited user interface display environment, comprising:
creating a hierarchy of menu commands in an application;
determining an availability of menu commands in the hierarchy of menu commands based upon a present state of the application; and
rendering the available menu commands in the limited user interface display environment, wherein the menu commands sequentially scroll across the limited user interface display environment.

12. The method of claim 11, wherein the plurality of items comprise icons.

13. The method of claim 11, wherein the plurality of items comprise short cut keys.

14. The method of claim 11, wherein the plurality of items comprise identification of available sources of streaming audio.

15. The method of claim 14, wherein selecting a desired item from the set of information comprises selecting a streaming audio signal from an audio source.

16. The method of claim 11, wherein the plurality of items comprise identification of available audio files.

17. The method of claim 16, wherein selecting a desired item from the set of information comprises selecting an audio source for download of an audio file.

18. The method of claim 11, wherein the plurality of items comprise identification of available sources of streaming video.

19. The method of claim 18, wherein selecting a desired item from the set of information comprises selecting a streaming video signal from a video source.

20. The method of claim 1, wherein the plurality of items comprise identification of available video files.
